(19) United States
(12) Patent Application Publication
(10) Pub. No.: US 2006/0167593 A1
(43) Pub. Date: Jul. 27, 2006

(54) Wireless vehicle performance information communication system

(75) Inventor: Robert V. Eckles, Cedar Rapids, IA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 11/040,859

(22) Filed: Jan. 21, 2005

(51) Int. Cl. G06F 7/00

(52) U.S. Cl. 701/1; 701/2

(57) ABSTRACT

Information related to operation of a vehicle is monitored by a vehicle performance information monitoring system. The information is gathered from an information bus of the vehicle and wirelessly transmitted to a user device upon occurrence of a transmission triggering event. The user device stores the information in a memory, and is operable to upload the information to a computer system. The computer system processes the information according to an application program.

### BACKGROUND OF THE INVENTION

This invention relates to a system for communicating information from the information bus of a vehicle to an external computer system.

Virtually all modern vehicles are constructed to include an electronic information bus that allows access to information regarding mileage driven, fuel consumed, component failure, and other vehicle performance parameters. The information bus is typically provided with an external connector that allows electronic equipment, such as a vehicle diagnostic computer system employed by a mechanic or a service center, to gather the performance information from the information bus. The current standard for storage and communication of this information is known as OBD-II (an acronym for on-board diagnostics).

Other applications for using the electronic information bus of a vehicle have been explored for management of vehicle fleets, such as rental cars, delivery trucks, and the like. For example, systems have been proposed that connect a transceiving computer to the information bus and to a global positioning system (GPS) receiver, to provide information related to the location, driving patterns, and other parameters to a remote location for monitoring.

While the applications and systems that have been proposed to date provide useful solutions for some industrial scenarios, there is a continuing need in the art for an improved system for monitoring vehicle performance information.

### BRIEF SUMMARY OF THE INVENTION

The present invention is a system and method for monitoring information related to operation of a vehicle. The information is gathered from an information bus of the vehicle and wirelessly transmitted to a user device upon occurrence of a transmission triggering event. The user device stores the information in a memory, and is operable to upload the information to a computer system. The computer system processes the information according to an application program.

### BRIEF DESCRIPTION OF THE DRAWINGS

FIG. 1 is a diagram illustrating a vehicle information monitoring system according to an embodiment of the present invention.

FIG. 2 is a flow diagram illustrating an example of the general operation of the system prof the present invention.

### DETAILED DESCRIPTION

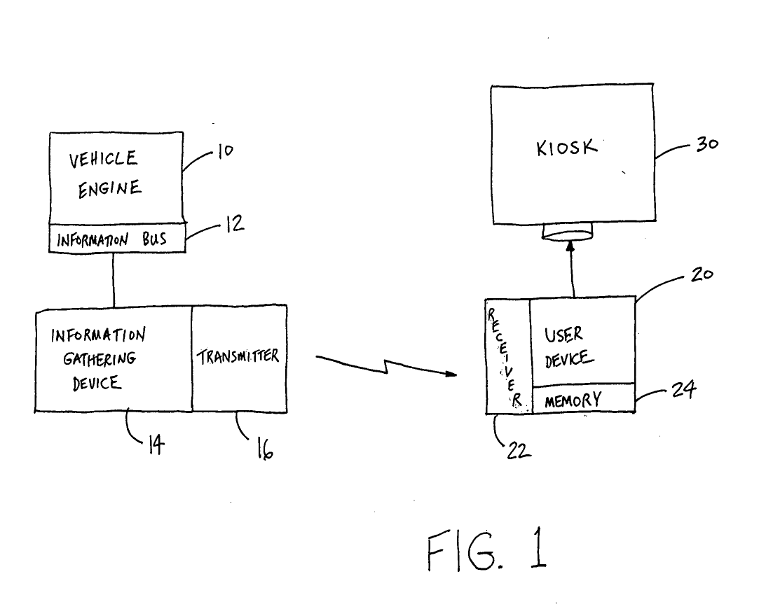

FIG. 1 is a diagram illustrating a vehicle information monitoring system according to an embodiment of the present invention. Vehicle engine 10 includes information bus 12, which provides access to information in electronic form representing various performance data associated with the operation of vehicle engine 10, such as fuel consumed, mileage driven, engine performance, or other parameters associated with operation of the vehicle. Information gathering device 14 is connected to receive data from information bus 12, utilizing a protocol as is known in the art to gather the performance data from information bus 12. Information gathering device 14 is connected to transmitter 16, which may be integrated into information gathering device 14 or may be an external transmitter that is coupled to information gathering device 14. In an exemplary embodiment, transmitter 16 is a short range, low power device such as a Bluetooth® radio transmitter, although many other types of transmitters could also be used.

Transmitter 16 transmits the vehicle performance information gathered by information gathering device 14 from information bus 12 to user device 20, where the information is received by receiver 22. Receiver 22 may be integrated into user device 20, or may be an external receiver that is coupled to user device 20. Again, in an exemplary embodiment, receiver 22 is a short range, low power device such as a Bluetooth® radio receiver, although many other types of receivers could also be used.

User device 20 includes memory 24 for storing the electronic information received by receiver 22 related to vehicle performance. User device 20 also has the capability of being coupled to kiosk computer system 30. Coupling user device 20 to kiosk computer system 30 allows user device 20 to communicate the vehicle performance information stored in memory 24 to kiosk computer system 30. This coupling may be achieved by physically inserting user device 20 into a receptacle of kiosk computer system 30, or may be achieved by short range, low power wireless communication, wired communication, or by another type of data communication. Kiosk computer system 30 is programmed with the capability to process selected types of data associated with vehicle performance that are stored in memory 24 of user device 20, such as fuel consumed, mileage driven, engine performance, or other types of data. Kiosk computer system 30 also runs appropriate application software so that the vehicle performance information received from user device 20 can be used to perform other functions such as determination of cost for a rental car, evaluation of driving performance for a vehicle operating as part of a delivery fleet, or other functions depending on the type of use of the vehicle. The application software may also involve a user interface and display to enable additional functions, such as point-of-sale capability or other functions.

One example of the operation of the vehicle monitoring system shown in FIG. 1 is in a rental car scenario. A consumer orders and picks up a rental car, and is given portable user device 20 that is supported on a key ring, for example. As the consumer drives the rental car, information gathering device 14 receives and stores data from information bus 12 that is indicative of vehicle performance or other parameters. Information gathering device 14 periodically transmits the data in response to a triggering event (such as every time the vehicle stops in one embodiment) via transmitter 16 to receiver 22 of user device 20. User device 20 stores this data in memory 24. When the user returns the rental car, kiosk computer system 30 is provided to allow the user to upload the data stored in memory 24 to settle their account when the user returns the car. In some embodiments, kiosk computer system 30 also includes point-of-sale capability to allow the user to pay on the account at the time of return. In other embodiments, kiosk computer system 30 simply produces a receipt or records the data for later generation of a bill to send to the user. This system allows a user to potentially complete the vehicle return process without the need for assistance from a human attendant or clerk (or at least with reduced numbers of attendants), which can reduce the cost to the rental car company associated with vehicle returns, and can also reduce the amount of time required for a user to complete a vehicle return.

The automated vehicle return system also allows the rental car company to recover the cost of fuel that has been consumed but does not register on the vehicle's analog gas gauge. Some studies have shown that rental car companies lose an average of 1.8 gallons of gasoline for each automobile rental where the distance the customer drives is not long enough for the fuel consumption to register on the analog gas gauge. Providing data from information bus 12 of the vehicle allows the rental car company to accurately determine actual fuel consumption and to recover the cost of the fuel consumption from the customer.

The system of the present invention may also be used in numerous other applications. For example, for vehicle fleet management, user device 20 can be issued to every driver or vehicle operator, to allow management to review vehicle performance, speed, distance, and other parameters on a personal, individual basis (rather than on a vehicle basis). In other words, the data follows the employee rather than the vehicle. This monitoring scheme allows meaningful review of employee performance to be done without limiting employees to a single vehicle. Other applications may employ the system as well, such as to safety lock a vehicle based on the identity of the personnel carrying user device 20, to provide information to a service center for quick analysis without having to physically connect to information bus 12, to identify a vehicle by VIN number (such as with a hand held device operated by security personnel, or by other means) as it passes through a secure entrance point for tracking of vehicle identities (such as whether a vehicle is stolen or has authorization to enter) and vehicle locations, or others. In addition, future applications not currently in existence may be developed based on the abilities provided by the present invention, such as monitoring of private vehicle operators to develop a driving record used for insurance and/or licensing purposes, for example. It will be appreciated that a wide variety of applications are contemplated as potential uses of the present invention.

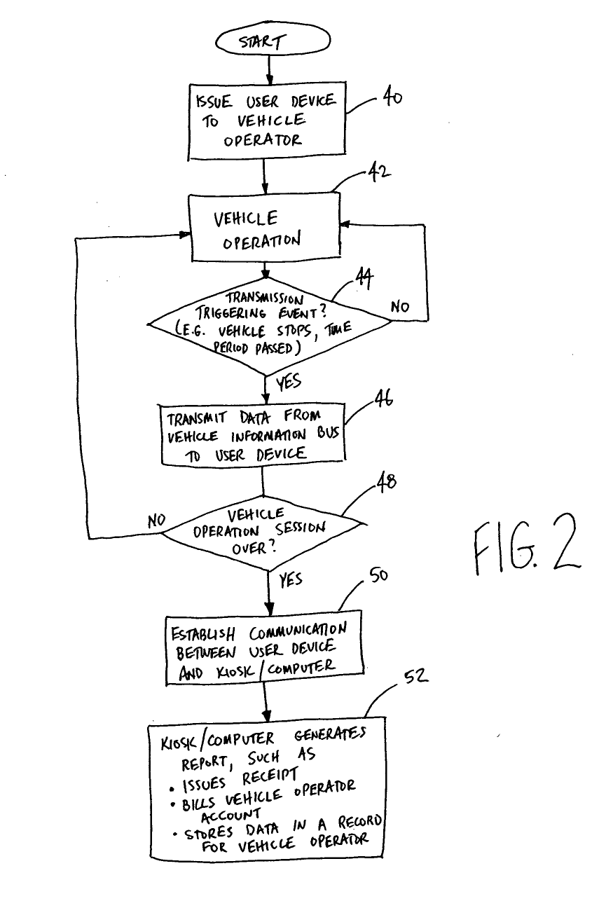

FIG. 2 is a flow diagram illustrating an example of the general operation of the system prof the present invention. The initial step is to issue a user device (such as user device 20 shown in FIG. 1) to a vehicle operator, as indicated at step 40. This user device has the ability to receive and store data transmitted from the information bus of the vehicle. The vehicle operator then operates the vehicle in the typical manner, depending on the vehicle application (as discussed above, many vehicle applications are possible), as indicated at step 42. As the vehicle is operated, events periodically occur which trigger the transmission of data from the vehicle information bus to the user device, as indicated at decision step 44. Examples of transmission triggering events may be stopping of the vehicle, opening of the driver's door, unhooking the driver's seat belt, opening the vehicle's trunk, or any other event associated with the vehicle that is (or could be) sensed electronically. In another embodiment, the transmission triggering event may simply be the passing of a time period (so that transmission occurs at regular time intervals), or other external events. If a transmission triggering event does not occur, vehicle operation continues normally. Occurrence of a transmission triggering event causes data to be transmitted from the vehicle information bus to the user device, as indicated at step 46.

Steps 42, 44 and 46 continue until the vehicle operation session is over, as indicated by decision step 48. The end of the vehicle operation session may be marked by return of the vehicle to its management area, such as the return of a rental car or a fleet vehicle, or by bringing a vehicle to a service center, for example. Other types of vehicle operation sessions are also possible. When the vehicle operation session ends, communication is established between the user device that was issued to the vehicle operator and a kiosk/computer system (such as kiosk computer system 30 shown in FIG. 1), as indicated at step 50. The user device transmits the data it received from the vehicle information bus to the kiosk/computer system for appropriate processing. In the exemplary operation shown in FIG. 2, the kiosk/computer system generates a report based on the data received from the user device, as indicated at step 52. This report generating step may take a variety of forms, such as issuance of a receipt to the vehicle operator, billing of the vehicle operator's account, storing the data in the vehicle operator's electronic record, or others. While steps 40, 42, 44, 46, 48 and 50 shown in FIG. 2 remain fairly similar for various applications of the present invention, report generation step 52 varies substantially depending on the application, as it embodies the specific application software that is executed by the kiosk/computer system.

The present invention provides the ability to monitor performance data and other parameters available on the information bus of a vehicle. A portable user device receives the information, and communicates with a kiosk computer system to upload the information for processing. The system therefore allows for automated review and analysis of vehicle data, which can be used in a wide variety of applications where vehicle monitoring is useful.

Although the present invention has been described with reference to preferred embodiments, workers skilled in the art will recognize that changes may be made in form and detail without departing from the spirit and scope of the invention.

1. A system for monitoring information related to operation of a vehicle, the system comprising:
an information gathering device connected to receive the information related to operation of the vehicle, the information gathering device including a wireless transmitter that is operable to transmit the information received upon occurrence of a transmission triggering event;
a user device having a memory and a wireless receiver for receiving the information transmitted by the information gathering device,
a computer system for acquiring the information from the user device and processing the information according to an application program.

2. The system of claim 1, wherein the transmission triggering event is the vehicle stopping.

3. The system of claim 1, wherein the transmission triggering event is the passage of a fixed amount of time.

4. The system of claim 1, wherein the user device is attached to a keyring for operating the vehicle.

5. The system of claim 1, wherein the wireless transmitter of the information gathering device and the wireless receiver of the user device are Bluetooth radios.

6. The system of claim 1, wherein the computer system is a kiosk that includes a physical interface for receiving the user device to acquire information therefrom.

7. The system of claim 1, wherein the computer system is a kiosk that includes a wireless communication interface for communicating with the user device to acquire information therefrom.

8. The system of claim 1, wherein the computer system is operable according to the application program to generate a report related to the information acquired from the user device.

9. A method of monitoring vehicle performance information comprising:
gathering vehicle performance information from an information bus of a vehicle;
wirelessly transmitting the vehicle performance information to a user device in response to occurrence of a transmission triggering event;
storing the vehicle performance information in a memory of the user device;
uploading the vehicle performance information from the user device to a computer system; and
processing the vehicle performance information according to an application program executed by the computer system.

10. The method of claim 9, wherein the transmission triggering event is the vehicle stopping.

11. The method of claim 9, wherein the transmission triggering event is the passage of a fixed amount of time.

12. The method of claim 9, wherein wirelessly transmitting the vehicle performance information to the user device comprises:
operating a first Bluetooth radio coupled to the information bus of the vehicle to transmit the vehicle performance information; and
operating a second Bluetooth radio in the user device to receive the vehicle performance informaton.

13. The method of claim 9, wherein uploading the vehicle performance information from the user device to the computer system comprises physically coupling the user device to the computer system.

14. The method of claim 9, wherein uploading the vehicle performance information from the user device to the computer system comprises wirelessly transmitting the vehicle performance information from the user device to the computer system.

15. The method of claim 9, wherein processing the vehicle performance information comprises analyzing the vehicle performance information to determine appropriate charges to assess as a result of operation of the vehicle.

16. The method of claim 15, further comprising generating a receipt for the charges assessed.

17. The method of claim 15, further comprising billing a vehicle operators account for the charges assessed.

18. The method of claim 9, wherein processing the vehicle performance information comprises analyzing the vehicle performance information to generate a performance record associated with an individual vehicle operator.
